(19) United States
(12) Patent Application Publication
(10) Pub. No.: US 2020/0228578 A1
(43) Pub. Date: Jul. 16, 2020

(54) Call Setup Method and Apparatus

(71) Applicant: Huawei Technologies Co., Ltd., Shenzhen (CN)

(72) Inventor: Yinyuan Jia, Shanghai (CN)

(21) Appl. No.: 16/614,904

(22) PCT Filed: May 19, 2017
(86) PCT No.: PCT/CN2017/085189

§ 371 Date: Dec. 16, 2019

(51) Int. Cl. H04L 29/06; H04W 76/36; H04W 68/00

(52) U.S. Cl. CPC H04L 65/1069; H04W 68/005; H04W 76/36; H04L 65/1016

(57) ABSTRACT

Embodiments of this application disclose a call setup method, and relate to the field of communications technologies. The method is used to resolve a problem that an LTE terminal cannot provide a voice service effectively. The method includes: receiving, by a terminal, a first notification message, where the first notification message includes a first IMS incoming call notification message; establishing, by the terminal, a first IMS call connection based on the first notification message, and allocating a resource for the first IMS call connection; receiving, by the terminal, a second notification message, where the second notification message includes any one of the following messages: a circuit switched CS notification message, an indication message sent by a network side device, and a second IMS incoming call notification message; and releasing, by the terminal based on the second notification message, the resource occupied by the first IMS call connection.

### TECHNICAL FIELD

This application relates to the field of communications technologies, and in particular, to a call setup method and apparatus.

### BACKGROUND

A voice over long term evolution (Long Term Evolution, LTE) (Voice over LTE, VoLTE) technology provides an LTE network with a voice solution based on an IP multimedia subsystem (Internet Protocol Multimedia Subsystem. IMS). In conventional 2G and 3G networks, a circuit switched (Circuit Switched, CS) network is used to transmit a voice. When a voice call is made through the CS network, a fixed channel is allocated to both parties through the CS network. In the VoLTE technology, high-speed bandwidth of the LTE network is used to transmit a voice. In this way, the voice call is transmitted through an IP network without occupying a conventional call channel. However, in a process of gradually deploying the LTE network, the conventional 2G and 3G networks and the LTE network need to coexist for a relatively long time. Therefore, most of existing terminals support both the LTE network and the conventional 2G and 3G networks, and can be handed over between the LTE network and the 2G and 3G networks. When processing a voice service, such a terminal usually establishes a call connection preferentially through an IMS network (namely, a voice solution provided based on the LTE network). When the call connection fails to be established through the IMS network, a call connection is established through the CS network (namely, a voice solution provided based on the 2G and 3G networks).

When a user uses the terminal to perform a voice service such as making or answering a call, user experience may be as follows: As shown in FIG. 1a, a first user uses a first terminal 11 to initiate a first call request to a second terminal 12 that is of a second user and that supports an LTE function. As shown in FIG. 1b, the first user and the second user successfully complete a first call, and duration of the first call is very short (call duration of 15 seconds is used as an example in FIG. 1b). As shown in FIG. 1c, within a very short time (for example, several seconds) after the first call ends, when the first user uses the first terminal 11 to re-initiate a second call request to the second user, even if the second user is not making any call by using the second terminal 12, the second terminal 12 still returns a message such as “BUSY” to reject the second call request. Actually, the second terminal 12 is not in a call state. Therefore, the existing terminal supporting the LTE function still has a problem that the terminal cannot effectively provide a new voice service when a previous voice service ends.

### SUMMARY

According to a first aspect, a call setup method is provided. The method is applied to a terminal, and the method includes: receiving, by the terminal, a first notification message, where the first notification message includes a first IMS incoming call notification message; then establishing, by the terminal, a first IMS call connection based on the first notification message, and allocating a resource for the first IMS call connection; and receiving, by the terminal, a second notification message, and then releasing, by the terminal based on the second notification message, a resource occupied by the first IMS call connection, where the second notification message includes any one of the following messages: a CS notification message, an indication message sent by a network side device, and a second IMS incoming call notification message.

The CS notification message includes any one of a CS incoming call notification message, a notification message indicating that a CS call connection is established, a message indicating that a CS call starts to be set up, and an indication message indicating that a CS call ends. The indication message sent by the network side device is used to instruct the terminal to release the resource occupied by the first IMS call connection.

In the foregoing method, in a process of establishing an IMS call connection, if the terminal receives any one of the CS notification message, the indication message sent by the network side device, and the second IMS incoming call notification message, it indicates that the IMS call connection fails. Consequently, the terminal releases in a timely manner a resource occupied by the IMS call connection that is in the establishment process, thereby saving resources.

Considering that when the terminal receives the second notification message, the terminal may currently already establish an IMS call connection successfully, and start a call by using the IMS call connection. To avoid a case in which the ongoing call is interrupted because a resource occupied by the IMS call connection in a call stage is released by mistake, optionally, in an implementation of the first aspect, the terminal determines, based on the second notification message, whether the first IMS call connection is in an establishment process; and if the first IMS call connection is in the establishment process, the terminal releases the resource occupied by the first IMS call connection that is in the establishment process.

Optionally, when the second notification message is the second IMS incoming call notification message, the second IMS incoming call notification message carries a second calling number and a second call identifier, and the first IMS incoming call notification message carries a first calling number and a first call identifier. In an implementation of the first aspect, the releasing, by the terminal based on the second notification message, a resource occupied by the first IMS call connection includes: determining, by the terminal through comparison, whether the first calling number is the same as the second calling number, and whether the first call identifier is the same as the second call identifier; and if the first calling number is the same as the second calling number, and the first call identifier is different from the second call identifier, releasing, by the terminal, the resource occupied by the first IMS call connection.

Optionally, in an implementation of the first aspect, after the releasing, by the terminal based on the second notification message, a resource occupied by the first IMS call connection, the method further includes: establishing, by the terminal, a second IMS call connection based on the second IMS incoming call notification message.

In the prior art, because the terminal does not release in a timely manner the resource occupied by the first IMS call connection, the terminal rejects a second IMS incoming call when receiving the second IMS incoming call notification message. In this implementation of this application, after the terminal releases the resource occupied by the first IMS call connection, the terminal may establish the second IMS call connection to respond to the second IMS incoming call notification message.

According to a second aspect, a terminal is provided, and includes: a receiving unit, configured to receive a first notification message, where the first notification message includes a first IMS incoming call notification message; a connection establishment unit, configured to establish a first IMS call connection based on the first notification message received by the receiving unit, and allocate a resource for the first IMS call connection, where the receiving unit is further configured to receive a second notification message, and the second notification message includes any one of the following messages; a circuit switched CS notification message, an indication message sent by a network side device, and a second IMS incoming call notification message, and a connection releasing unit, configured to release, based on the second notification message received by the receiving unit, a resource occupied by the first IMS call connection.

Optionally, the CS notification message includes any one of a CS incoming call notification message, a notification message indicating that a CS call connection is established, a message indicating that a CS call starts to be set up, and an indication message indicating that a CS call ends. The indication message sent by the network side device is used to instruct the terminal to release the resource occupied by the first IMS call connection.

In an implementation of the second aspect, the connection releasing unit is further configured to: determine, based on the second notification message, whether the first IMS call connection is in an establishment process, and when the first IMS call connection is in the establishment process, release the resource occupied by the first IMS call connection that is in the establishment process.

In an implementation of the second aspect, the second notification message is the second IMS incoming call notification message, the first IMS incoming call notification message carries a first calling number and a first call identifier, and the second IMS incoming call notification message carries a second calling number and a second call identifier. The connection releasing unit is further configured to: determine, through comparison, whether the first calling number is the same as the second calling number, and whether the first call identifier is the same as the second call identifier; and when the first calling number is the same as the second calling number, and the first call identifier is different from the second call identifier, release the resource occupied by the first IMS call connection.

In an implementation of the second aspect, the connection establishment unit is further configured to establish a second IMS call connection based on the second IMS incoming call notification message.

According to a third aspect, a terminal is provided. The terminal includes a transceiver, one or more processors, and a memory. The memory is configured to store computer program code, the computer program code includes an instruction, and when the one or more processors execute the instruction, the terminal performs the method in the first aspect.

According to a fourth aspect, a computer readable storage medium is provided. The computer readable storage medium stores an instruction, and when the instruction is run on a computer, the computer is enabled to perform the method in the first aspect.

According to a fifth aspect, a computer program product is provided. The computer program product includes an instruction, and when the instruction is run on a computer, the computer is enabled to perform the method in the first aspect.

### BRIEF DESCRIPTION OF DRAWINGS

FIG. 1a is a schematic interface diagram in which a calling terminal initiates an IMS call request to an LTE terminal in the prior art;

FIG. 1b is a schematic interface diagram in which a calling terminal and an LTE terminal set up a CS call based on a call request;

FIG. 1c is a schematic interface diagram in which an LTE terminal rejects an IMS call request that is initiated by a calling terminal after the CS call shown in FIG. 1b ends in the prior art;

FIG. 2 is a schematic structural diagram of a mobile phone supporting an LTE function;

FIG. 3a is a schematic flowchart of interaction for that an LTE terminal establishes an IMS call connection in the prior art;

FIG. 3b is a schematic flowchart of interaction for that an LTE terminal rejects a second IMS call request after receiving the second IMS call request in a process of establishing an IMS call connection in the prior art;

FIG. 4 is a schematic flowchart of interaction for a call setup method according to an embodiment of this application:

FIG. 4a-1 and FIG. 4a-2 are a schematic diagram of a log log of allocating a resource for an IMS call connection according to an embodiment of this application;

FIG. 4b is a schematic diagram of a log log of releasing a resource occupied by an IMS call connection according to an embodiment of this application:

FIG. 5, FIG. 5a, and FIG. 5b are schematic flowcharts of interaction for another call setup method according to an embodiment of this application;

FIG. 6 and FIG. 6a are schematic flowcharts of interaction for still another call setup method according to an embodiment of this application;

FIG. 7 is a schematic flowchart of interaction for that a called terminal rejects a second call request after a calling terminal initiates a first call request, then cancels the first call request, and further initiates the second call request:

FIG. 8 is a schematic flowchart of interaction for yet another call setup method according to an embodiment of this application;

FIG. 9 is a schematic flowchart of interaction for still yet another call setup method according to an embodiment of this application;

FIG. 10 is a schematic structural diagram of a terminal according to an embodiment of this application;

FIG. 10a is a schematic structural diagram of another terminal according to an embodiment of this application; and

FIG. 10b is a schematic structural diagram of still another terminal according to an embodiment of this application.

### DESCRIPTION OF EMBODIMENTS

A network side device in embodiments of this application is a collective name of a core network and an access network device that are responsible for processing a voice service, and includes a session border controller (Session Border Controller. SBC) of a core network, a proxy-call session control function (Proxy Call Session Control Function, P-CSCF) device, a serving-call session control function (Serving Call Session Control Function, S-CSCF) device, an application server (Application Server, AS), a home subscriber server (Home Subscriber Server, HSS), and the like. The network side device further includes a device such as an evolved NodeB (Evolved Node B, eNB) of an access network. For functions and interaction of these devices, reference may be made to the prior art, and details are not described in the embodiments of this application. This application mainly relates to a processing process of a terminal. Therefore, for ease of description, these devices are collectively referred to as a network side device in the embodiments of this application. It may be understood that a calling-side network device is configured to interact with a calling terminal in a call setup process. A called-side network device is configured to interact with a called terminal in a call setup process.

With development of communications technologies, an increasing number of terminals support LTE functions. For example, the terminal supporting the LTE function is a mobile phone. As shown in FIG. 2, the mobile phone 100 includes components such as a radio frequency (radio frequency, RF) circuit 110, a memory 120, an input unit 130, a modem 140, a processor 150, a power supply 160, a display unit 170, a gravity sensor 180, and an audio frequency circuit 190. A person skilled in the art may understand that the structure of the mobile phone shown in FIG. 2 does not constitute any limitation to the mobile phone, and more or less components than those shown in the figure may be included, or some components may be combined, or a different component layout may be used.

Functional components of the mobile phone 100 are separately described below.

The RF circuit 110 may be configured to send and receive signals in an information sending and receiving process or in a call process. Particularly, the RF circuit 110 receives downlink information from a base station, then delivers the downlink information to the processor 150 for processing, and additionally sends uplink data to the base station. Generally, the RF circuit includes but is not limited to an antenna, at least one amplifier, a transceiver, a coupler, a low noise amplifier (low noise amplifier, LNA), a duplexer, and the like. In addition, the RF circuit 110 may also communicate with a network and another device through wireless communication. For the wireless communication, any communications standard or protocol may be used, including but is not limited to a global system for mobile communications (global system of mobile communications, GSM), a general packet radio service (general packet radio service, GPRS), code division multiple access (Code Division Multiple Access, CDMA), wideband code division multiple access (Wideband Code Division Multiple Access, WCDMA), long term evolution (Long Term Evolution, LTE), an email, a short message service (short messaging service, SMS), and the like.

The memory 120 may be configured to store a software program and module. The processor 150 runs the software program and module stored in the memory 120, to implement various functional applications and data processing of the mobile phone 100. The memory 120 may mainly include a program storage area and a data storage area. The program storage area may store an operating system, an application program (Application, APP) required by at least one function such as a voice play function or an image play function. The data storage area may store data (such as audio data, image data, and an address book) and the like that are created based on use of the mobile phone 100. In addition, the memory 120 may include a high speed random access memory, and may further include a nonvolatile memory such as at least one magnetic disk storage device, a flash memory, or another volatile solid-state storage device.

The input unit 130 may be configured to receive entered digit or character information, and generate a key signal input related to a user setting and function control of the mobile phone 100. Specifically, the input unit 130 may include a touchscreen 131 and another input device 132. The touchscreen 131 is also referred to as a touch panel, and may collect a touch operation (for example, an operation performed by a user on or near the touchscreen 131 by using any proper object or accessory such as a finger or a stylus) performed by the user on or near the touchscreen 131, and drive a corresponding connection apparatus by using a preset program. Optionally, the touchscreen 131 may include two parts: a touch detection apparatus and a touch controller. The touch detection apparatus detects a touch position of the user, detects a signal brought by a touch operation, and transfers the signal to the touch controller. The touch controller receives touch information from the touch detection apparatus, converts the touch information into coordinates of a touch point, and then sends the coordinates of the touch point to the processor 150. In addition, the touch controller can receive and execute a command sent by the processor 150. In addition, the touchscreen 131 may be implemented in various types such as a resistance type, a capacitance type, an infrared type, and a surface acoustic wave type. In addition to the touchscreen 131, the input unit 130 may include another input device 132. Specifically, the another input device 132 may include but is not limited to one or more of a physical keyboard, a function key (such as a volume control key or a power on/off key), a trackball, a mouse, a joystick, and the like.

The modem 140 may be logically divided into a CS module, an LTE module, and a VoLTE module based on a service carried by the modem 140, where the CS module is used to carry a CS service, the LTE module is used to carry a data service of an LTE network, and the VoLTE module is used to carry a VoLTE service.

The display unit 170 may be configured to display information entered by the user or information provided for the user, and various menus of the mobile phone 100. The display unit 170 may include a display panel 171. Optionally, the display panel 171 may be configured by using a liquid crystal display (Liquid Crystal Display, LCD), an organic light-emitting diode (Organic Light-Emitting Diode, OLED), or the like. Further, the touchscreen 131 may cover the display panel 171. After detecting a touch operation on or near the touchscreen 131, the touchscreen 131 transfers the touch operation to the processor 150, to determine a type of a touch event. Then, the processor 150 provides a corresponding visual output on the display panel 171 based on the type of the touch event. Although the touchscreen 131 and the display panel 171 in FIG. 2 are used as two independent components to implement input and output functions of the mobile phone 100, in some embodiments, the touchscreen 131 and the display panel 171 may be integrated to implement the input and output functions of the mobile phone 100.

The gravity sensor (gravity sensor) 180 may detect magnitude of acceleration of the mobile phone in various directions (which are generally tri-axial), may detect magnitude and a direction of gravity when the mobile phone is static, and may be used for an application that identifies a mobile phone gesture (for example, switching between a horizontal screen and a vertical screen, a related game, and magnetometer gesture calibration), a function related to vibration identification (for example, a pedometer and a knock), and the like.

The mobile phone 100 may further include another sensor, for example, an optical sensor. Specifically, the light sensor may include an ambient light sensor and a proximity sensor. The ambient light sensor may adjust brightness of the display panel 131 based on brightness of ambient light. The proximity sensor may detect whether there is an object approaching or touching the mobile phone, and may turn off the display panel 131 and/or backlight when the mobile phone 100 is moved to an ear. A gyroscope, a barometer, a hygrometer, a thermometer, an infrared sensor, and other sensors may be further configured for the mobile phone 100. Details are not described herein.

The audio frequency circuit 190, a loudspeaker 191, and a microphone 192 may provide an audio interface between the user and the mobile phone 100. The audio frequency circuit 190 may convert received audio data into an electrical signal, and transmit the electrical signal to the loudspeaker 191. The loudspeaker 191 converts the electrical signal into a sound signal and outputs the sound signal. The microphone 192 converts a collected sound signal into an electrical signal. The audio frequency circuit 190 receives the electrical signal, converts the electrical signal into audio data, and then outputs the audio data to the RF circuit 110, so that the RF circuit 110 sends the audio data to, for example, another mobile phone, or outputs the audio data to the memory 120 for further processing.

The processor 150 is a control center of the mobile phone 100, and is connected to various parts of the mobile phone by using various interfaces and lines. By running or executing the software program and/or the module stored in the memory 120, and invoking data stored in the memory 120, the processor 150 performs various functions and data processing of the mobile phone 100, thereby performing overall monitoring on the mobile phone. Optionally, the processor 150 may include one or more processing units. Optionally, the processor 150 may integrate an application processor and a modem processor. The application processor mainly processes an operating system, a user interface, an application program, and the like. The modem processor mainly processes wireless communication. It may be understood that the foregoing modem processor may alternatively not be integrated into the processor 150.

The mobile phone 100 further includes a power supply 160 (such as a battery) for supplying power to the components. Optionally, the power supply may be logically connected to the processor 150 by using a power management system, thereby implementing functions such as charging, discharging and power consumption management by using the power management system.

Although not shown, the mobile phone 100 may further include an antenna, a wireless-fidelity (Wireless-Fidelity, WiFi) module, a near field communication (Near Field Communication, NFC) module, a. Bluetooth module, a loudspeaker, an accelerometer, a gyroscope, and the like.

Currently, for an LTE terminal, when a VoLTE function is enabled on the terminal, the terminal initiates LTE registration by sending an EMM_ATTACH_REQ message to a network side, where the message carries a registration type field and a voice domain capability field. Generally, the registration type field indicates joint registration, namely, registration with both PS domain and CS domain. A value “ims voice perferred cs voice as secondary” of a voice domain capability means both an IMS voice and a CS voice are supported and a priority of the IMS voice is higher than that of the CS voice. After the LTE registration succeeds, and the LTE terminal receives a registration success response message (EMM_ATTACH_ACP) that is sent by the network side and that carries a field indicating that the network side also supports an IMS capability, the LTE terminal initiates an IMS public data network (Public Data Network, PDN) activation process, and then initiates an IMS registration process to register with an IMS core network. For a specific implementation process in which the LTE terminal registers with an LTE network and an IMS network, reference may be made to the prior art, and details are not described herein.

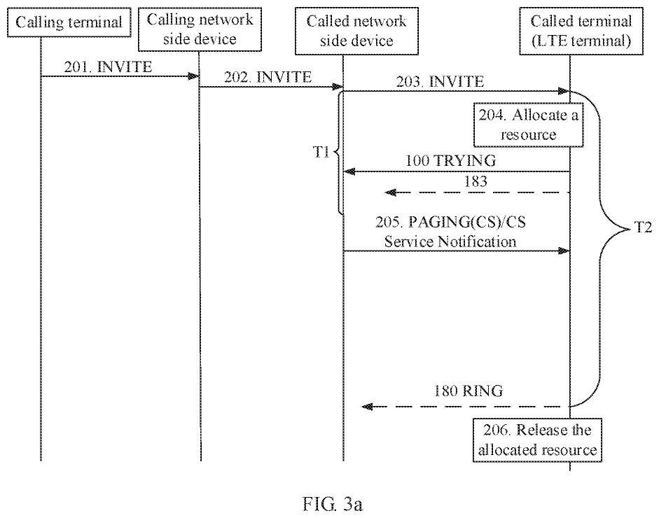

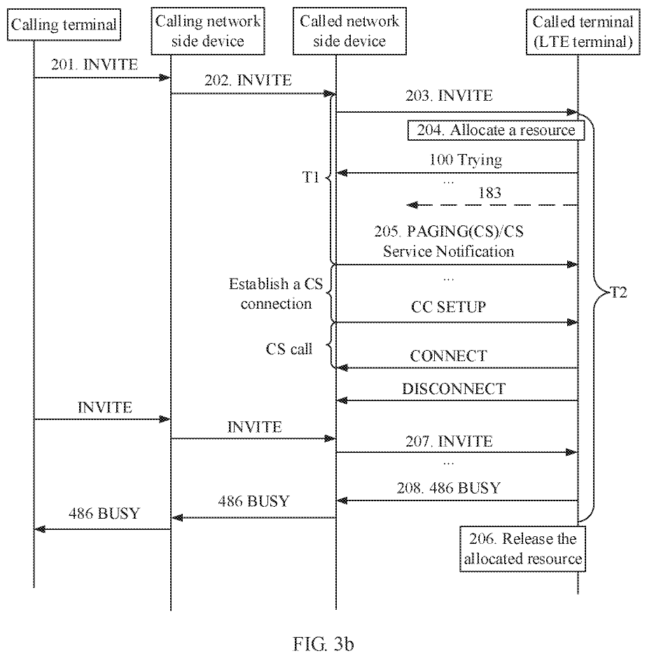

In this way, when there is a new call request, a network side device checks a voice domain capability of the terminal; and when the voice domain capability carried by the terminal is “ims voice perferred cs voice as secondary”, the call request is completed preferentially through the IMS network. When the call request cannot be completed through the IMS network, the call request falls back to a CS network, and is completed through the CS network. Specifically, as shown in FIG. 3a, a process in which another terminal initiates a call to an LTE terminal and establishes a call connection as a calling terminal includes the following steps.

201. The calling terminal sends a call request to a calling-side network device.

The calling terminal may be a mobile terminal such as a mobile phone, or may be a fixed terminal such as a landline phone. The calling terminal may be a terminal that supports an LTE function, or may be a terminal that supports only 2G and 3G functions. The call request sent by the calling terminal may be an IMS call request, or may be a conventional CS call request, and a type of the call request is not limited.

In FIG. 3a, an example in which the call request is the IMS call request is used for description. To be specific, the calling terminal sends an INVITE request message to the calling-side network device.

202. The calling-side network device sends the INVITE request message to a called-side network device.

203. The called-side network device sends the INVITE request message to the LTE terminal, and starts a CS-retry (CS-Retry) timer T1.

During specific implementation of this step, after the called-side network device receives the INVITE request message sent by the calling-side network device, the called-side network device checks a voice domain capability of the LTE terminal to determine that the LTE terminal supports an IMS call. When the called-side network determines that the LTE terminal supports the IMS call, the called-side network forwards the INVITE request message to the LTE terminal through the IMS network, to notify the LTE terminal that there is a new incoming call from the IMS network.

It should be noted that, in step 201, if the type of the call request sent by the calling terminal to the calling-side network device is a non-IMS call request, for example, a CS call request, after receiving the CS call request sent by the calling-side network device, the called-side network device converts the CS call request into an IMS call request, and sends the IMS call request to the LTE terminal.

After sending the INVITE request message to the LTE terminal, the called-side network device starts the CS-retry timer T1. Before the CS-retry timer T1 expires, if a specific message, for example, a 183 Session Progress message sent by the terminal when resource reservation is supported, or a 180 RING message sent by the terminal when resource reservation is not supported, sent by the LTE terminal is not received by the called-side network device, the called-side network device considers that a call connection fails to be established through the IMS network, and then re-initiates CS paging to the LTE terminal, to establish a call connection through the CS network and complete the call.

204. After receiving the INVITE request message sent by the called-side network device, the LTE terminal starts a timer T2, starts to establish an IMS network call connection, and allocates a resource for the IMS network call connection.

Herein, the timer T2 is a wait-for-ringing timer and/or transaction timer (transaction timer). A timing length of the wait-for-ringing timer is usually about 60 s, and a timing length of the transaction timer is usually about 185 s. Because terminals belong to different manufacturers, after the terminal receives the INVITE message, the terminal may start only the transaction timer, or may start only the wait-for-ringing timer, or may start both the transaction timer and the wait-for-ringing timer.

After receiving the INVITE message sent by the called-side network device, the LTE terminal starts the timer T2, creates a thread, allocates memory, and reserves media resources such as an audio resource and a video resource, a related instance of IMS protocol initialization, and the like for the IMS network call request.

If the LTE terminal rings before T2 expires, it indicates that the IMS network call connection is successfully established, and both parties can start a call. If the LTE terminal does not ring before T2 expires, the LTE terminal considers that the IMS network call connection fails to be established, and then releases the allocated resource.

205. After T1 expires, the called-side network device initiates CS paging to the LTE terminal to establish a CS call connection, and completes the call through the CS network after the CS call connection succeeds.

As described above, when sending the INVITE message to the terminal, the network side device starts the CS-retry timer T1. However, in actual application, because signal quality of the IMS network is poor, the CS-retry timer T1 started by the network side device expires, and the network side device negotiates with the terminal, to establish the CS call connection and complete the call through the CS network. Reasons of causing T1 expiry include: Before the CS-retry timer T1 expires, the network side device has not received a 183 Session Progress message or a 180 RING message; or before the CS-retry timer T1 expires, the network side device has not received a 100 TRYING message returned by the terminal. After the CS-retry timer T1 expires, the network side device considers that the IMS call connection fails to be established, and starts to fall back to the CS network to complete the call connection.

When the LTE terminal is in an idle state, the called-side network device sends a CS Paging message to the LTE terminal. When the LTE terminal is in a non-idle state, the called-side network device sends a CS Service Notification message to the LTE terminal.

206. After T2 expires, the terminal releases the resource allocated in step 204.

For a specific implementation process of step 201 to step 206, reference may be made to the prior art, and details are not described in this embodiment of this application.

The inventor finds in research that in the foregoing scenario, a timing length of the CS-retry timer T1 started by the called-side network device is about a dozen of seconds, and a timing length of the timer T2 started by the LTE terminal is one minute to three minutes. Therefore, when T1 expires because communication quality of the IMS network is poor and consequently a specific message returned by the LTE terminal is not received by the network side device, the network side device considers that the IMS network call connection fails to be established, and re-initiates the CS call connection to the LTE terminal through the CS network to complete the call. However, because a CS service and an IMS call service are two services independent of each other, a CS module carries the CS service, a VoLTE module carries the IMS service, and there is a lack of communication between the CS module and the VoLTE module. Consequently, when the CS service of the CS module starts to be set up, an IMS call connection of the IMS module is still in an establishment process, and still occupies the resource in step 204, resulting in resource waste.

In addition, the inventor finds in research that in the prior art, as shown in FIG. 3b, before T2 that is started when a first call request is received expires, when the terminal receives a second call request, the terminal rejects the second call request. This process includes the following steps.

207. The terminal receives an INVITE request message sent by the network side device.

Herein, the INVITE request message indicates that the terminal receives a second IMS call request.

208. The terminal returns a “486 BUSY” message to the network side device.

The inventor finds that a reason why the terminal rejects the second call request when receiving the second call request is as follows: Because the previous IMS call connection of the LTE terminal is not released, the terminal considers that the previous IMS call connection is in the establishment process, and regards the new IMS call request as a second incoming call. As a result, the LTE terminal sends a “486 Busy” message or the like based on protocol specifications to reject the new call request, and consequently the new incoming call cannot be set up. In this case, the new call request is sent after a first IMS call request falls back to the CS network to set up a CS call and the CS call ends, and the terminal actually does not have any valid call connection. However, because the LTE terminal considers that the IMS call connection is currently in an establishment process, the terminal cannot establish a new IMS call connection.

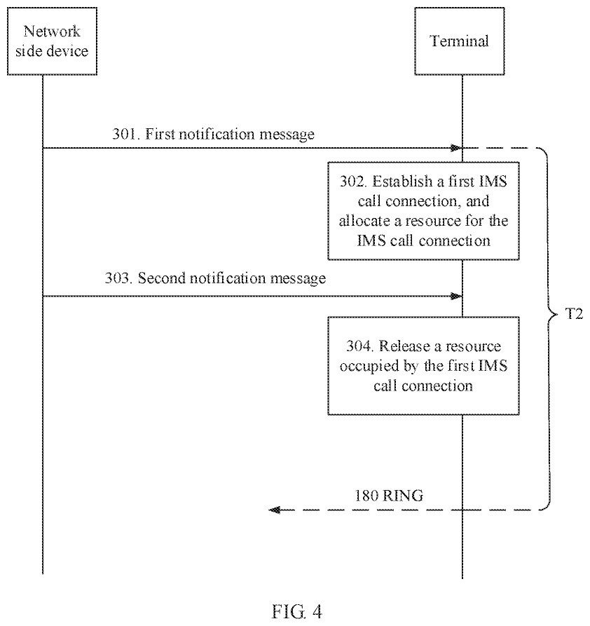

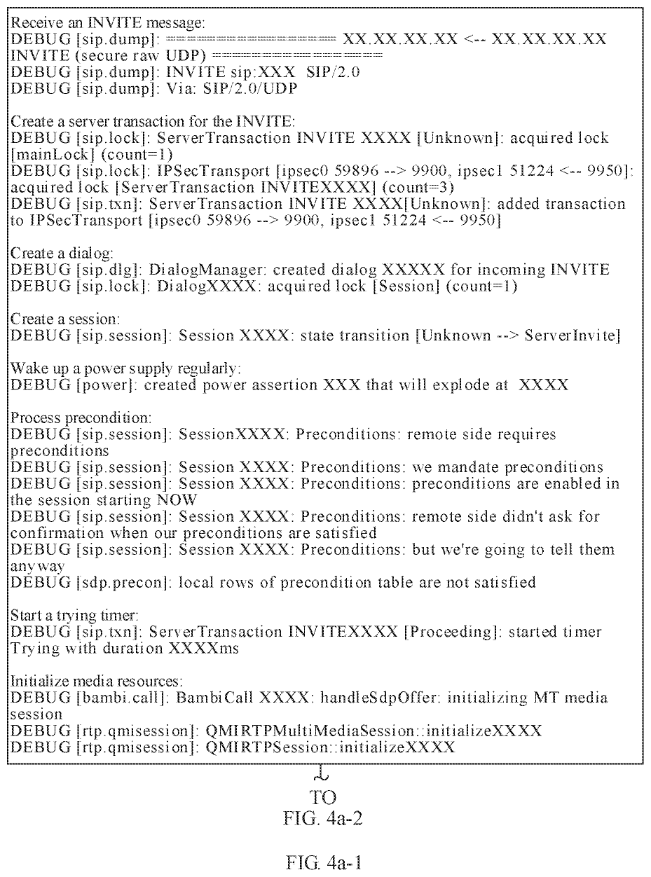

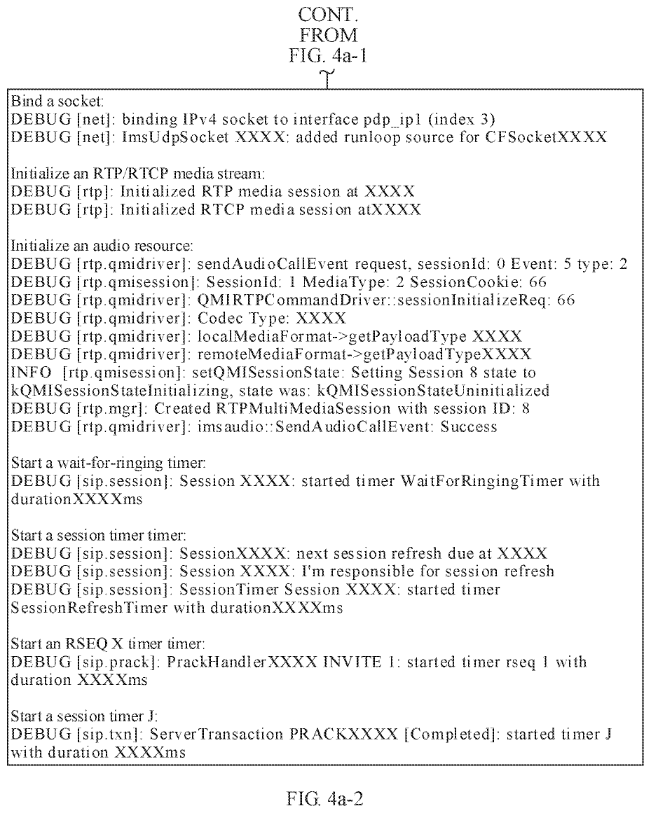

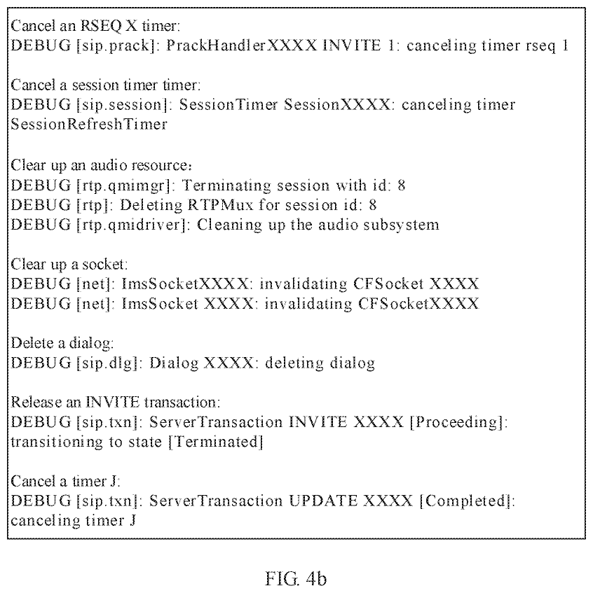

To resolve the foregoing problem, an embodiment of this application provides a call connection establishment method. As shown in FIG. 4, the method includes the following steps.

301. A terminal receives a first notification message.

302. The terminal establishes a first IMS call connection based on the first notification message, and allocates a resource for the first IMS call connection.

The first notification message is an IMS incoming call notification message. The IMS incoming call notification message is used to notify the terminal that there is an IMS incoming call. After receiving the IMS incoming call notification message, the terminal starts to establish an IMS call connection, and allocates a resource for the IMS call request.

Specifically, the IMS incoming call notification message is an INVITE message. After receiving the INVITE message, the terminal starts to establish the IMS call connection, creates a thread, allocates a resource, and the like for the IMS call connection to be established. The resource includes memory, reserved media resources such as an audio resource and a video resource, and a transmission resource such as a related instance of IMS protocol initialization.

In addition, after receiving the INVITE message, the terminal starts a timer T2. Before the timer T2 expires, the terminal successfully sends a 180 RING message to a network side device, indicating that the IMS call connection is successfully established. Otherwise, before T2 expires, the terminal is always in an IMS call connection establishment process.

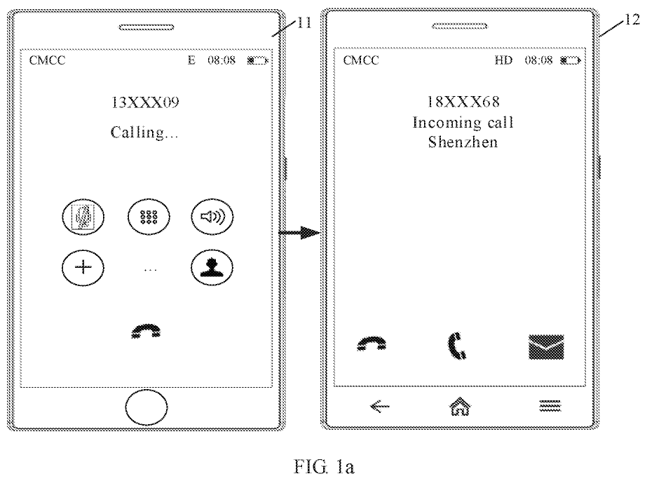

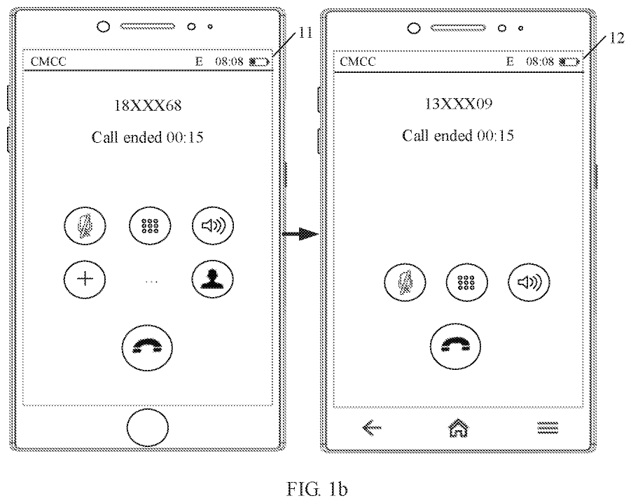

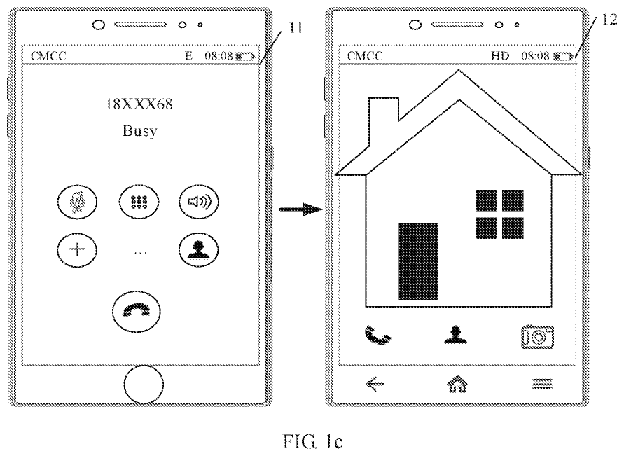

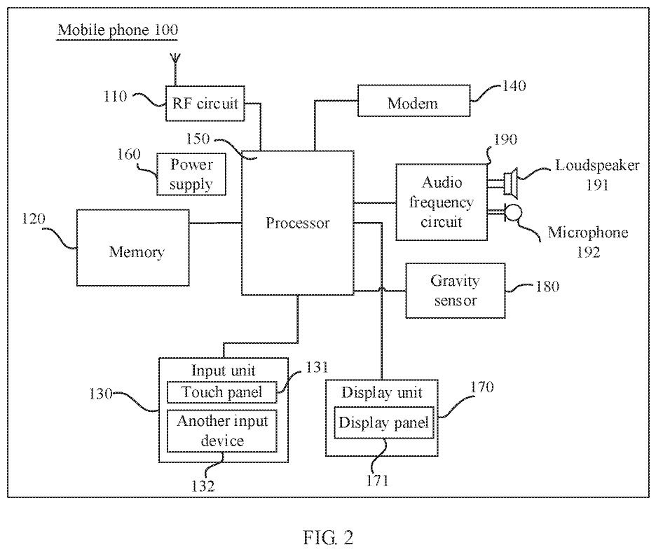

For example, as shown in FIG. 4a-1 and FIG. 4a-2, after receiving the INVITE request message, the terminal starts to establish an IMS call connection, and allocates a resource for the IMS call connection. A process of allocating the resource includes one or more of the following actions: creating a server transaction, creating a dialog, setting up a session, waking up a power supply regularly, processing resource reservation (precondiction), starting a trying timer, initializing media resources, binding a socket, initializing an RTP/RTCP media stream, initializing an audio resource, starting a wait-for-ringing timer, starting a session timer timer, starting an RSEQ X timer timer, and starting a session timer J timer.

303. The terminal receives a second notification message.

Optionally, the second notification message includes any one of the following messages: a circuit switched CS notification message, an indication message sent by a network side device, and a second IMS incoming call notification message.

The CS notification message is any message in a process in which a call request falls back from an IMS network to a CS network, a CS call connection is established, and a CS call is set up after the CS call connection is established.

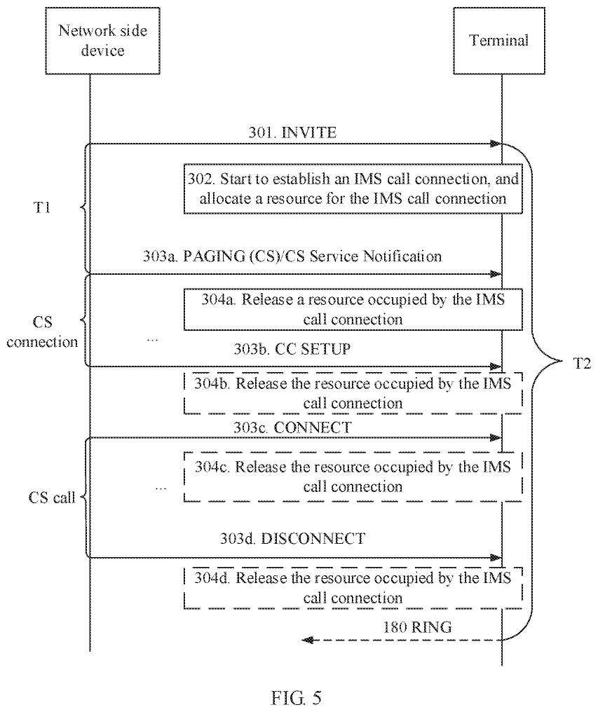

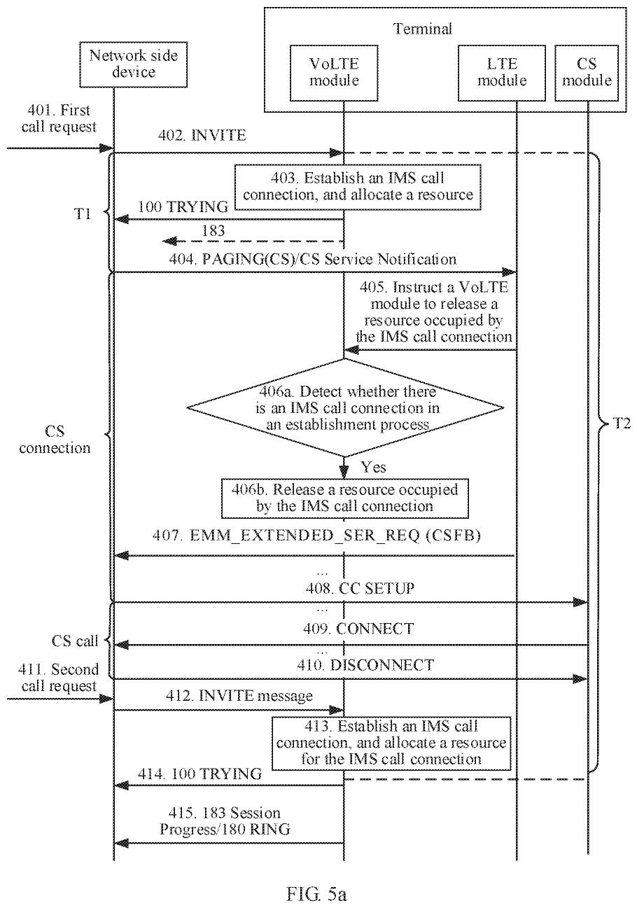

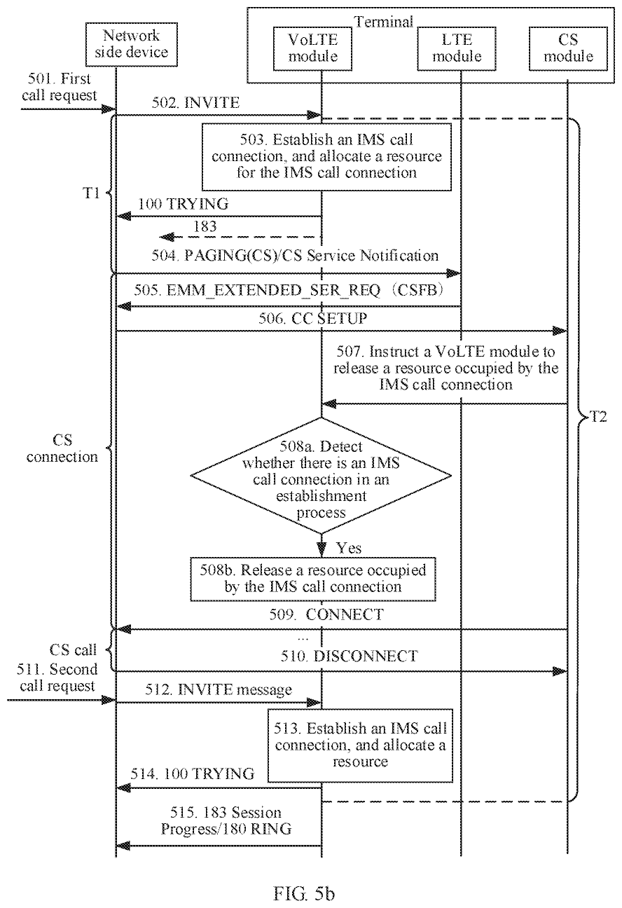

For example, as shown in FIG. 5, the CS notification message is a CS incoming call notification message. The CS incoming call notification message includes a CS paging (Paging) message sent by the network side device when the terminal is in an idle (Idle) state; or the CS incoming call notification message further includes a CS service notification (CS Service Notification) message sent by the network side device when the terminal is in a non-idle state. The CS Paging message and the CS Service Notification message are used to indicate, to the terminal, that there is a new CS incoming call. Optionally, the CS notification message may alternatively be a CS call connection setup (CS Connection SETUP) indication message sent by the network side device. Optionally, the CS notification message may alternatively be an indication message indicating that a call is started after a CS call connection is successfully established, for example, a CONNECT message; or may be a call completion indication message indicating that a call ends, for example, a DISCONNECT message.

When the network side device considers that the IMS network is unavailable, the network side device instructs the terminal to fall back to the CS network to complete the call. Therefore, when the terminal receives the CS notification message, it indicates that an IMS connection that is being currently established may be invalid, or the network side has released the IMS connection, so that the terminal performs the following step 304.

The indication message sent by the network side device is an indication message sent to the terminal after the network side device determines that the IMS call connection fails to be established, and the indication message is used to instruct the terminal to release a resource occupied by the IMS call connection that is currently being established. Therefore, when the terminal receives the indication message, it indicates that the IMS call connection that is currently being established may be invalid, or the network side has released the IMS call connection, so that the terminal performs the following step 304.

304. The terminal releases, based on the second notification message, a resource occupied by the first IMS call connection.

For example, as shown in FIG. 4b, after receiving the CS notification message, the terminal releases the resource occupied by the IMS call connection. A process of releasing the resource occupied by the IMS call connection includes one or more of the following actions: canceling the RSEQ X timer timer, canceling the session timer timer, releasing the audio resource, clearing the socket, deleting the created dialog, deleting the server transaction created after the INVITE is received, and canceling the session timer J timer.

In the foregoing method, in a process of establishing the IMS call connection, if the terminal receives the second notification message, where the second notification message may be the CS notification message, the indication message sent by the network side device, or the second IMS incoming call notification message, the terminal releases in a timely manner the resource occupied by the IMS call connection that is in an establishment process, thereby saving resources.

Considering that when the terminal receives the second notification message, the terminal may currently have successfully established an IMS call connection, and started a call by using the IMS call connection. To avoid a case in which the ongoing call is interrupted because a resource occupied by the IMS call connection in a call stage is released by mistake, before step 304, the method further includes: determining, by the terminal based on the second notification message, whether the first IMS call connection is in an establishment process; and if the first IMS call connection is in the establishment process, releasing, by the terminal, the resource occupied by the first IMS call connection that is in the establishment process.

During specific implementation, after receiving the second notification message, the terminal queries whether there is a call entity currently being maintained, and queries a status of the call entity. When the status of the call entity is a call setup state, an IMS resource occupied by the IMS call is released. When the status of the call entity is another state, for example, a ringing or calling state, the resource occupied by the IMS call connection does not need to be released.

In actual application, a modem may be logically divided into a VoLTE module, an LTE module, a CS module, a 2G/3G module, and the like based on a transmission service type. The VoLTE module is configured to carry an IMS service, the LTE module is configured to carry a data service of an LTE network, CS module is configured to carry a CS service, and the 2G and 3G module is used to carry a data service of 2G and 3G networks.

In an implementation, an LTE module of the terminal instructs a VoLTE module to release an IMS call connection that is currently in an establishment process.

For example, an embodiment of this application provides a call connection establishment method. In the method, when the terminal is in an idle state, the LTE module of the terminal receives a CS Paging message sent by a network side device, or when the terminal is in a non-idle state, the LTE module of the terminal receives a CS Service Notification message sent by the network side device, and then the LTE module of the terminal instructs the VoLTE module to release a resource occupied by an IMS call connection that is in an establishment process. As shown in FIG. 5a, the method includes the following steps.

401. The network side device receives a first call request.

Herein, the first call request is initiated by a calling terminal, and is forwarded by a calling-side network device to a called-side network device. A type of the call request is not limited. In FIG. 5a, the call request is an IMS call request. To be specific, an example in which the call request is an INVITE message is used for description.

402. The network side device sends the INVITE message to a VoLTE module of a called terminal, and starts a CS-retry timer T1.

403. After receiving the INVITE message, the VoLTE module of the terminal establishes an IMS call connection, and allocates a resource for the IMS call connection.

In addition, after receiving the INVITE message, the terminal further needs to return a 100 TRYING message to the network side device. The 100 TRYING message indicates that the terminal has received the INVITE message.

404. When the CS-retry timer T1 started by the network side device expires, the network side device determines whether the terminal is in an idle state; and if the terminal is in an idle state, the network side device sends a CS Paging message to an LTE module of the terminal; or if the terminal is in a non-idle state, the network side device sends a CS Service Notification message to the LTE module of the terminal.

The CS Paging or CS Service Notification message is used to notify the terminal that there is a CS call, and that a CS call connection starts to be established.

405. The LTE module of the terminal sends an indication message to the VoLTE module.

The indication message is used to instruct the VoLTE module to release a resource occupied by the IMS call connection that is currently in an establishment process. A specific implementation of the indication message may be customized by a manufacturer of the terminal.

In step 404, after the LTE module of the terminal receives the CS Paging message or the CS Service Notification message, it indicates that a call request from a CS network is received. This indicates that the call connection fails to be established through the IMS network, and the LTE module instructs the VoLTE module to release the resource allocated for the IMS call connection.

It can be learned that, in this embodiment of this application, a process of communication between the LTE module and the VoLTE module in the terminal is added, so that the LTE module can instruct the VoLTE module in a timely manner to release the resource occupied by the IMS call connection that is currently in the establishment process.

406a: After receiving the indication message sent by the LTE module, the VoLTE module of the terminal detects whether there is an IMS call connection currently in an establishment process.

Optionally, after receiving the indication message sent by the LTE module, the VoLTE module of the terminal detects whether there is an IMS call connection currently in an establishment process. If there is an IMS call connection currently in the establishment process, the following step 406b is performed. If there is an IMS call connection through which a call is started, the VoLTE module of the terminal does not need to release a resource occupied by the IMS call connection through which the call is started. For a specific implementation, reference may be made to the prior art, and details are not described herein. If there is neither an IMS call connection in an establishment process, nor an IMS call connection that is already established and that is being used for an IMS call, it indicates that the VoLTE module does not occupy a resource, and the VoLTE module of the terminal does not need to release any resource.

406b. The VoLTE module of the terminal releases a resource occupied by the IMS call connection.

407. The LTE module of the terminal returns an EMM_EXTENDED_SER_REQ (CSFB) message to the network side device.

The EMM_EXTENDED_SERREQ (CSFB) message indicates that the terminal has received a CS incoming call notification message, and the terminal accepts a circuit switched fallback (Circuit Switched Fallback, CSFB) request of the network side device. After receiving the message, the network side instructs the terminal to be handed over to 2G/3G to set up a CS call.

408. The network side device sends a CC SETUP message to a CS module of the terminal.

The CC SETUP message indicates that a CS call connection is successfully established.

409. The CS module of the terminal sends a CONNECT message to the network side device.

The CONNECT message indicates that the calling party and the called party start a call through the CS network.

410. The CS module of the terminal sends a DISCONNECT message to the network side device, or receives a DISCONNECT message sent by the calling terminal.

The DISCONNECT message indicates that the CS call ends. When the calling terminal ends the call, the terminal receives the DISCONNECT message sent by the network side device. When the called terminal ends the call, the terminal sends the DISCONNECT message to the network side device. An example in which the called terminal ends the call is used for description.

Then, when the terminal receives a new incoming call, even if before T2 expires, the terminal may respond to the new incoming call, and this process includes the following steps.

411. The network side device receives a second call request.

For a specific implementation of the process, refer to step 401, and details are not described herein again.

412. The network side device sends an INVITE message to the VoLTE module of the terminal.

413. After receiving the INVITE message sent by the network side device, the VoLTE module of the terminal starts to establish a new IMS call connection, and allocates a resource for the IMS call connection.

414. The VoLTE module of the terminal returns a 100 TRYING message to the network side device.

415. The VoLTE module of the terminal returns a 183 Session Progress message or a 180 RING message to the network side device.

Then, the terminal completes the call through the CS network. For a specific implementation, reference may be made to the prior art, and details are not described herein.

It should be noted that the foregoing signaling, such as the INVITE, 100 TRYING 183 Session Progress, and 180 RING messages are signaling specified in a session initiation protocol (Session Initiation Protocol. SIP). Messages such as the CS Paging, CS Service Notification, EMM_EXTENDED_SER_REQ (CSFB), CC SETUP, CONNECT, and DISCONNECT are signaling related to a CS call. For a specific implementation, reference may be made to the prior art, and details are not described herein.

It can be learned that, in the method shown in FIG. 5a, after receiving the CS Paging or CS Service Notification message sent by the network side device, the LTE module of the terminal instructs the VoLTE module to release the resource occupied by the IMS call connection that is currently in the establishment process.

Optionally, in another implementation, a process of communication between the CS module and the VoLTE module is added, and the CS module instructs the VoLTE module to release the resource occupied by the IMS call connection.

For example, after the CS module of the terminal receives the CC SETUP message sent by the network side device, the CS module instructs the VoLTE module to release the resource occupied by the IMS call connection. As shown in FIG. 5b, the method includes the following steps.

501. The network side device receives a first call request.

502. The network side device sends an INVITE message to the VoLTE module of a called terminal, and starts a CS-retry timer T1.

503. After receiving the INVITE message, the VoLTE module of the terminal establishes an IMS call connection, and allocates a resource for the IMS call connection.

504. When the CS-retry timer T1 started by the network side device expires, the network side device determines whether the terminal is in an idle state; and if the terminal is in an idle state, the network side device sends a CS Paging message to an LTE module of the terminal; or if the terminal is in a non-idle state, the network side device sends a CS Service Notification message to the LTE module of the terminal.

505. The LTE module of the terminal returns an EMM_EXTENDED_SER_REQ (CSFB) message to the network side device.

506. The network side device sends a CC SETUP message to the CS module of the terminal.

507. The CS module of the terminal sends an indication message to the VoLTE module, where the indication message is used to instruct the VoLTE module to release a resource occupied by the IMS call connection.

By using the step, communication between the CS module and the VoLTE module is added, so that the CS module can instruct in a timely manner, after a CS call connection is successfully established, the VoLTE module to release the IMS call connection that is currently in an establishment process.

508a. After receiving the indication message sent by the CS module, the VoLTE module of the terminal detects whether there is an IMS call connection currently in an establishment process.

508b. The VoLTE module of the terminal releases a resource occupied by the IMS call connection.

For a specific implementation of the foregoing steps 508a and 508b, reference may be made to steps 406a and 406b, and details are not described herein again.

509. The CS module of the terminal sends a CONNECT message to the network side device.

The CONNECT message indicates that the calling party and the called party start a call through a CS network.

Optionally, because step 508a and step 508b are performed by the VoLTE module, step 509 is performed by the LTE module. Therefore, step 509 may be performed before step 508a and step 508b, or may be performed simultaneously with step 508a and step 508b. This is not limited in this embodiment.

510. The CS module of the terminal sends a DISCONNECT message to the network side device, or receives a DISCONNECT message sent by a calling terminal.

Then, before T2 expires, when the terminal receives a new incoming call, the terminal may respond to the new incoming call, and this process includes the following steps:

511. The network side device receives a second call request.

512. The network side device sends an INVITE message to the VoLTE module of the terminal.

513. The VoLTE module of the terminal receives the INVITE message sent by the network side device, then establishes a second call connection, and allocates a resource for the second call connection.

514. The VoLTE module of the terminal returns a 100 TRYING message to the network side device.

515. The VoLTE module of the terminal returns a 183 Session Progress message or a 180 RING message to the network side device.

Optionally, in another implementation, step 507, step 508a, and step 508b may be performed after step 506, or may be performed after step 509 or step 510. For example, after the CS call ends, the CS module instructs the VoLTE module to release the IMS call connection that is currently in the establishment process. In this way, only a small modification is made to an existing protocol.

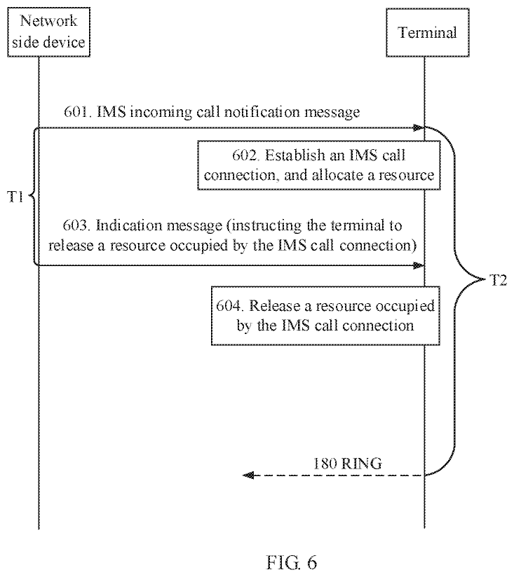

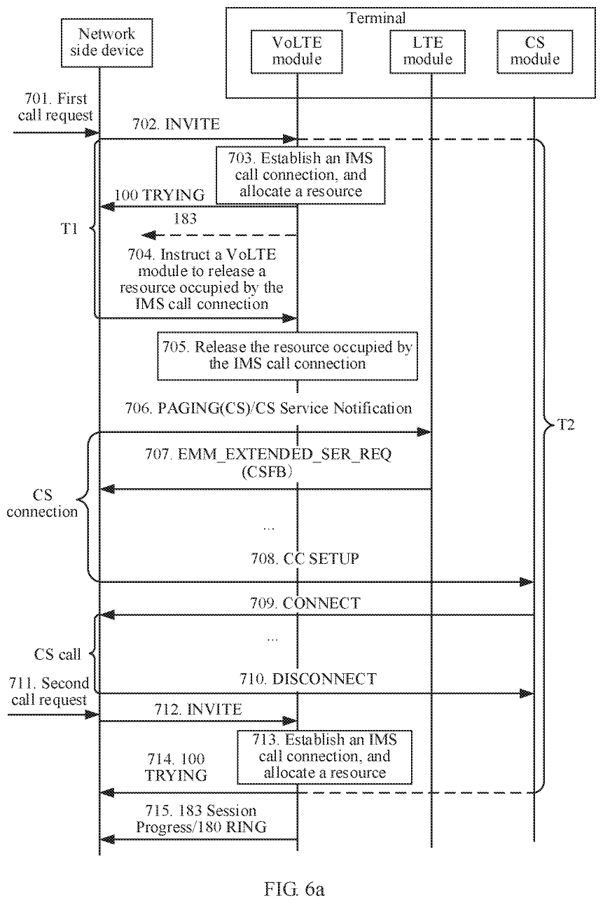

In another implementation, when the network side device fails to establish the IMS call connection, the network side device instructs the terminal to fall back to the CS network, to establish the CS call connection, and complete the call request through the CS network. Therefore, the network side device sends the indication message to the terminal after determining that the IMS call connection fails, where the indication message is used to instruct the terminal to release the resource occupied by the IMS call connection that is currently in the establishment process. Therefore, an embodiment of this application further provides a call setup method. As shown in FIG. 6, the method includes the following steps.

601. A terminal receives an IMS incoming call notification message.

602. The terminal establishes an IMS call connection based on the IMS incoming call notification message, and allocates a resource for the IMS call connection.

For specific implementations of step 601 and step 602, reference may be made to step 301 and step 302, and details are not described herein again.

603. The terminal receives an indication message sent by a network side device.

Herein, the indication message is used to instruct the terminal to release a resource occupied by the IMS call connection that is currently in an establishment process. The indication message carries an identifier of the terminal, an indication field, and the like, and a specific value of the indication field is used to instruct the terminal to release the IMS call connection that is currently in the establishment process. The indication message may be a newly defined message, or may use an existing message by adding the indication field into idle bytes of the existing message.

The indication message is sent by the network side device to the terminal. Specifically, when sending an INVITE message to the terminal, the network side device starts a CS-retry timer T1. After T1 expires, if the network side device still does not receive a specific message returned by the terminal, the network side device considers that the IMS call connection fails to be established; and after T1 expires, the network side device sends the indication message to the terminal.

604. The terminal releases, based on the indication message, a resource occupied by the IMS call connection.

In the foregoing method, when the network side device determines that the IMS call connection fails to be established, the network side device instructs the terminal to release in a timely manner the resource occupied by the IMS call connection that is in the establishment process, thereby saving resources.

For example, after the CS-retry timer T1 expires, the network side device instructs a VoLTE module of the terminal to release the resource occupied by the IMS call connection that is in the establishment process. In this case, as shown in FIG. 6a, the method includes the following steps:

701. The network side device receives a first call request.

702. The network side device sends an INVITE message to the VoLTE module of the terminal, and starts a CS-retry timer T1.

703. After receiving the INVITE message, the VoLTE module of the terminal establishes an IMS call connection, and allocates a resource for the IMS call connection.

704. When the CS-retry timer T1 started by the network side device expires, the network side device sends an indication message to the VoLTE module of the terminal, where the indication message is used to instruct the VoLTE module to release a resource occupied by the IMS call connection that is currently in an establishment process.

705. After receiving the indication message sent by the network side device, the VoLTE module of the terminal releases the resource occupied by the IMS call connection.

Optionally, after receiving the indication message in step 704, the terminal returns a response message to the network side device, to indicate that the terminal has received the indication message.

706. The network side device determines whether the terminal is in an idle state; and if the terminal is in an idle state, the network side device sends a CS Paging message to an LTE module of the terminal; or if the terminal is in a non-idle state, the network side device sends a CS Service Notification message to the LTE module of the terminal.

707. The LTE module of the terminal returns an EMM_EXTENDED_SER_REQ (CSFB) message to the network side device.

708. The network side device sends a CC SETUP message to a CS module of the terminal.

709. The CS module of the terminal sends a CONNECT message to the network side device.

710. The CS module of the terminal sends a DISCONNECT message to the network side device, or receives a DISCONNECT message sent by a calling terminal.

After step 704 and step 705, the terminal releases in a timely manner, based on the indication message of the network side device, the resource occupied by the IMS call connection; and then the terminal may respond to a new IMS call request.

711. The network side device receives a second call request.

712. The network side device sends an INVITE message to the VoLTE module of the terminal.

713. After receiving the INVITE message sent by the network side device, the VoLTE module of the terminal starts to establish a new IMS call connection, and allocates a resource for the IMS call connection.

714. The VoLTE module of the terminal returns a 100 TRYING message to the network side device.

715. The VoLTE module of the terminal returns a 183 Session Progress message or a 180 RING message to the network side device.

Then, the terminal interacts with the network side device to complete a call. For a specific implementation, reference may be made to the prior art, and details are not described herein.

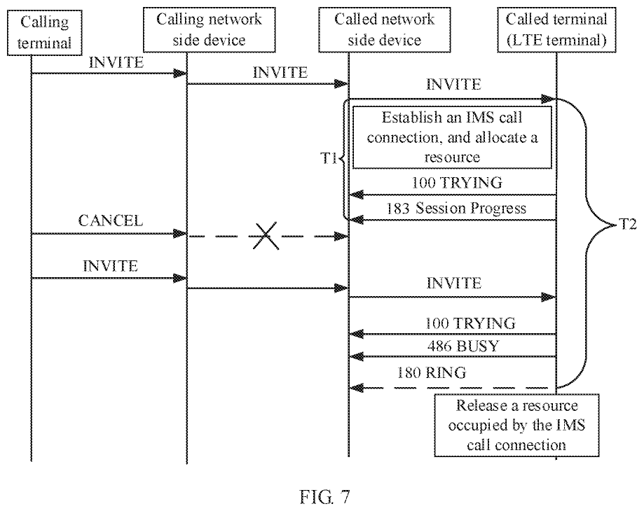

In actual application, the inventor finds in a research process that, the following case may occur: As shown in FIG. 7, a calling terminal initiates a first call request, and after receiving the call request, a called terminal establishes an IMS call connection and allocates a resource for the IMS call connection. Before the IMS call connection is successfully established, that is, before T2 that is started by the called terminal for the first call request expires, the calling terminal sends a CANCEL message to cancel the call. However, due to poor network communication quality, the CANCEL message is not received by the called terminal, and consequently the IMS call connection of the called terminal is always in an establishment process. In this way, when the calling terminal re-initiates a call request, because the IMS call connection is currently in the establishment process, the called terminal directly returns “486 BUSY” to reject the second call request initiated by the calling terminal.

To resolve the foregoing problem, in an implementation, the terminal receives a first IMS incoming call notification message, establishes a first IMS call connection based on the first IMS incoming call notification message, and allocates a resource for the first IMS call connection; and the terminal receives a second IMS incoming call notification message, and releases, based on the second IMS incoming call notification message, a resource occupied by the first IMS call connection.

In the foregoing implementation, when the terminal receives a second IMS call request in the establishment process of the first IMS call connection, the terminal releases the resource occupied by the first IMS call connection, and responds to the second IMS call request.

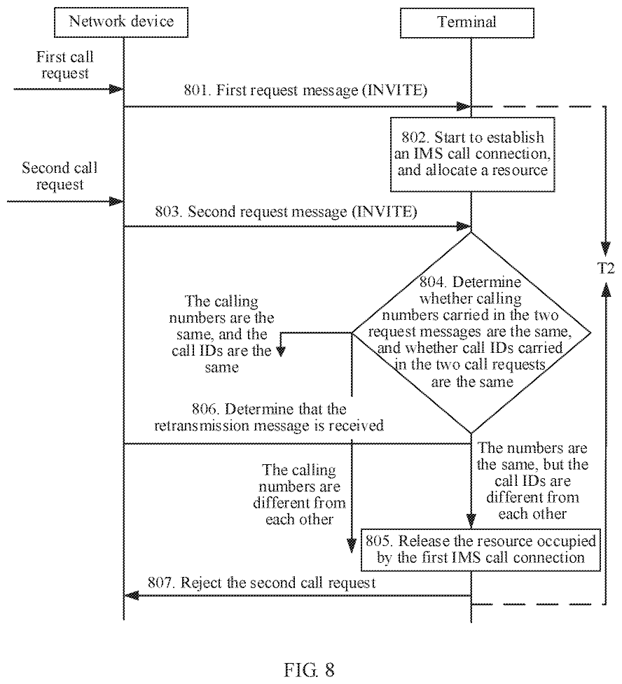

In another optional manner, an embodiment of this application further provides a call request setup method. As shown in FIG. 8, the method includes the following steps.

801. A terminal receives a first IMS incoming call notification message.

802. The terminal establishes a first IMS call connection based on the first IMS incoming call notification message, and allocates a resource for the first IMS call connection.

Herein, the first IMS incoming call notification message carries a first calling number and a first call identifier (CALL ID).

803. The terminal receives a second IMS incoming call notification message.

Herein, the second IMS incoming call notification message is used to notify the terminal that there is a second call request from an IMS network. The second IMS incoming call notification message carries a second calling number and a second call identifier.

Specifically, the second IMS incoming call notification message is an INVITE message. In the prior art, after receiving the INVITE message again, the terminal directly rejects the second IMS incoming call because the call connection of the first IMS incoming call is in an establishment process; while in this embodiment of this application, whether a resource occupied by the call connection of the first IMS incoming call needs to be released is determined based on the following steps.

804. The terminal determines, through comparison, whether the first calling number is the same as the second calling number, and whether the first call identifier is the same as the second call identifier.

If the first calling number is the same as the second calling number, and the first call identifier is different from the second call identifier, the following step 805 is performed.

If the first calling number is the same as the second calling number, and the first call identifier is the same as the second call identifier, it indicates that the second IMS incoming call notification message is an IMS retransmission packet, and the following step 806 is performed.

If the first calling number is different from the second calling number, the following step 807 is performed.

805. The terminal releases a resource occupied by the first IMS call connection, and responds to the second IMS call request.

In this step, after releasing the resource occupied by the first IMS call connection, the terminal establishes a new IMS call connection for the second IMS call, allocates a resource, and returns a “183 Session Progress” or “180 RING” message to a network side device, to respond to the second call request.

806. The terminal re-returns an acknowledgment message.

In this step, the terminal re-returns the acknowledgment message to indicate that the terminal receives the retransmission packet.

807. The terminal rejects the second IMS call request.

In this step, the terminal returns “486 BUSY” to reject the second IMS call request. For a specific implementation, reference may be made to the prior art, and details are not described herein.

In the foregoing method, when the terminal receives a new IMS call request, if there is an IMS call connection in an establishment process, the terminal determines whether a calling number and a call ID that are carried in the new IMS call request are respectively the same as a calling number and a call ID that are carried in the IMS call connection currently in the establishment process. If the calling numbers are the same but the call IDs are different from each other, it indicates that the new call request and the IMS call connection in the establishment process are initiated by a same calling terminal, and the IMS call connection in the establishment process may be a failed or invalid call connection. Consequently, the terminal releases a resource occupied by the IMS call connection that is in the establishment process, and responds to a new IMS call connection. According to the foregoing method, an IMS call connection success rate can be increased.

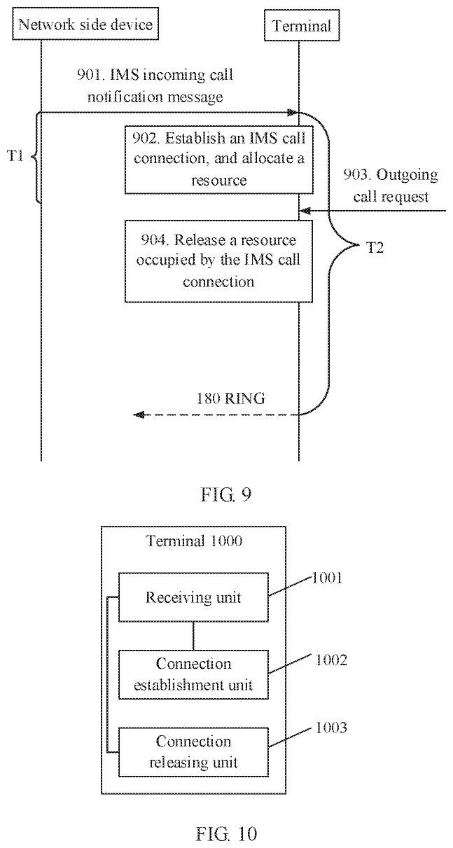

In actual application, there may be a scenario in which if the network side device sends an INVITE message to the terminal, after receiving the INVITE message, the terminal starts to allocate a resource and establishes an IMS call connection, and before the terminal rings, the terminal is always in an IMS call connection establishment process. However, for a user, the user does not know that there is a new incoming call until the terminal rings. Before the terminal rings, the user considers that the terminal is always in a no-call state. Therefore, in the IMS call connection establishment process, the user may use the terminal to dial a number to send a new call request. To avoid a case in which the user cannot use the terminal to send a call request because a resource is occupied by the IMS call connection, in this scenario, an embodiment of this application further provides a call setup method. As shown in FIG. 9, the method includes the following steps:

901. A terminal receives an IMS incoming call notification message.

902. The terminal establishes an IMS call connection based on the IMS incoming call notification message, and allocates a resource for the IMS call connection.

903. The terminal receives an outgoing call request.

For example, the outgoing call request includes: dialing a number by the user by using the terminal, where a dialing request is the outgoing call request.

904. The terminal releases, based on the outgoing call request, a resource occupied by the IMS call connection.

In the foregoing method, when the terminal receives the outgoing call request of the user, such as the dialing request, indicating that the user wants to use the terminal to make a call, the terminal releases in a timely manner a resource occupied by a current IMS call connection, to ensure that the user can make a call successfully.

The foregoing mainly describes the solutions provided in the embodiments of this application from the perspective of interaction between network elements. It can be understood that, to implement the foregoing functions, the network elements such as the network side device and the terminal include corresponding hardware structures and/or software modules for executing the functions. A person skilled in the art may be very easily aware that, in combination with the examples described in the embodiments disclosed in the embodiments of this application, units and algorithm steps may be implemented by hardware or a combination of hardware and computer software in this application. Whether a function is implemented by hardware or in a manner of driving hardware by computer software depends on a particular application and design constraint condition of the technical solution. A person skilled in the art may use different methods to implement the described functions for each particular application, but it should not be considered that the implementation goes beyond the scope of this application.

In this embodiment of this application, functional modules of the network elements may be divided based on the foregoing method examples. For example, functional modules may be divided corresponding to functions, or two or more functions may be integrated into one processing module. The integrated module may be implemented in a form of hardware, or may be implemented in a form of a functional module of software. It should be noted that the module division in the embodiments of this application is an example, and is merely logical function division. There may be another division manner in an actual implementation.

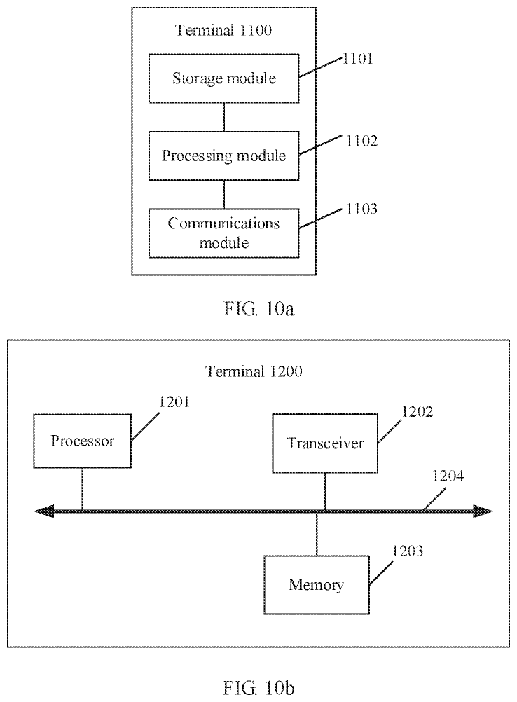

In a case in which functional modules are divided by using corresponding functions, FIG. 10 is a possible schematic structural diagram of the terminal in the foregoing embodiments. The terminal 1000 includes a receiving unit 1001, a connection establishment unit 1002, and a connection releasing unit 1003. The receiving unit 1001 is configured to support the terminal 1000 in receiving a first notification message, where the first notification message includes a first IMS incoming call notification message. The connection establishment unit 1002 is configured to support the terminal 1000 in establishing a first IMS call connection based on the first notification message received by the receiving unit 1001 and allocating a resource for the first IMS call connection. The receiving unit 1001 is further configured to support the terminal 1000 in receiving a second notification message, where the second notification message includes any one of the following messages: a circuit switched CS notification message, an indication message sent by a network side device, and a second IMS incoming call notification message. The connection releasing unit 1003 is configured to support the terminal 1000 in releasing, based on the second notification message received by the receiving unit 1001, a resource occupied by the first IMS call connection.

Optionally, the connection releasing unit 1003 is further configured to determine, based on the second notification message, whether the first IMS call connection is in an establishment process; and when the first IMS call connection is in the establishment process, release the resource occupied by the first IMS call connection that is in the establishment process.

Optionally, the second notification message is a second IMS incoming call notification message, and the first IMS incoming call notification message carries a first calling number and a first call identifier. The second IMS incoming call notification message carries a second calling number and a second call identifier. The connection releasing unit 1003 is further configured to: determine, through comparison, whether the first calling number is the same as the second calling number, and whether the first call identifier is the same as the second call identifier; and when the first calling number is the same as the second calling number, and the first call identifier is different from the second call identifier, release the resource occupied by the first IMS call connection. Correspondingly, the connection establishment unit 1002 is further configured to establish a second IMS call connection based on the second IMS incoming call notification message.

All related content of each step in the foregoing method embodiments may be cited in function descriptions of a corresponding function module. Details are not described herein again.

In a case in which an integrated unit is used, FIG. 10a is a possible schematic structural diagram of the terminal in the foregoing embodiments. The terminal 1100 includes a processing module 1102 and a communications module 1103. The processing module 1102 is configured to control and manage an action of the terminal 1100, and the communications module 1103 is configured to support the terminal 100 in communicating with another network entity. Specifically, the communications module 1103 is configured to support the terminal 1100 in receiving a first notification message, where the first notification message includes a first IP multimedia subsystem IMS incoming call notification message. The processing module 1102 is configured to support the terminal 1100 in establishing a first IMS call connection based on the first notification message, and allocating a resource for the first IMS call connection. The communications module 1103 is further configured to support the terminal 1100 in receiving a second notification message, where the second notification message includes any one of the following messages: a circuit switched CS notification message, an indication message sent by a network side device, and a second IMS incoming call notification message. The processing module 1102 is further configured to support the terminal 1100 in releasing, based on the second notification message, a resource occupied by the first IMS call connection.

Optionally, the processing module 1102 is further configured to: determine, based on the second notification message, whether the first IMS call connection is in an establishment process; and when the first IMS call connection is in the establishment process, release the resource occupied by the first IMS call connection that is in the establishment process.

Optionally, the second notification message is a second IMS incoming call notification message, and the first IMS incoming call notification message carries a first calling number and a first call identifier. The second IMS incoming call notification message carries a second calling number and a second call identifier. The processing module 1102 is further configured to: determine, through comparison, whether the first calling number is the same as the second calling number, and whether the first call identifier is the same as the second call identifier; and when the first calling number is the same as the second calling number, and the first call identifier is different from the second call identifier, release the resource occupied by the first IMS call connection. In addition, the processing module 1102 is further configured to establish a second IMS call connection based on the second IMS incoming call notification message.

All related content of each step in the foregoing method embodiments may be cited in function descriptions of a corresponding function module. Details are not described herein again.

The processing module 1102 may be a processor or a controller, such as a central processing unit (Central Processing Unit, CPU), a general purpose processor, a digital signal processor (Digital Signal Processor, DSP), an application-specific integrated circuit (Application-Specific Integrated Circuit, ASIC), a field programmable gate array (Field Programmable Gate Array, FPGA), or another programmable logic device, a transistor logic device, a hardware component, or any combination thereof. The processor/controller may implement or execute various example logical blocks, modules, and circuits described with reference to content disclosed in this application. Alternatively, the processor may be a combination for implementing a computing function, for example, a combination including one or more microprocessors or a combination of the DSP and a microprocessor. The communications module 1103 may be a transceiver, a transceiver circuit, a communications interface, or the like. A storage module 1101 may be a memory.

When the processing module 1102 is a processor, the communications module 1103 is a transceiver, and the storage module 1101 is a memory, the terminal in this embodiment of this application may be the terminal shown in FIG. 10b.

As shown in FIG. 10b, the terminal 1200 includes a processor 1201, a transceiver 1202, a memory 1203, and a bus 1204. The transceiver 1202, the processor 1201, and the memory 1203 are connected to each other by using the bus 1204. The bus 1204 may be a peripheral component interconnect (Peripheral Component Interconnect, PCI) bus, an extended industry standard architecture (Extended Industry Standard Architecture, EISA) bus, or the like. The bus may be classified into an address bus, a data bus, a control bus, and the like. For convenience of representation, only one bold line is used for representation in FIG. 10b, but it does not indicate that there is only one bus or one type of bus.

Method or algorithm steps described in combination with the content disclosed in this application may be implemented by hardware, or may be implemented by a processor by executing a software instruction. The software instruction may include a corresponding software module. The software module may be stored in a random access memory (Random Access Memory, RAM), a flash memory, a read-only memory (Read Only Memory, ROM), an erasable programmable read only memory (erasable programmable ROM, EPROM), an electrically erasable programmable read only memory (Electrically EPROM, EEPROM), a register, a hard disk, a mobile hard disk, a compact disc read-only memory (CD-ROM), or any other form of storage medium well-known in the art. For example, a storage medium is coupled to a processor, so that the processor can read information from the storage medium or write information into the storage medium. Certainly, the storage medium may be a component of the processor. The processor and the storage medium may be located in the ASIC.

A person skilled in the art should be aware that in the foregoing one or more examples, functions described in this application may be implemented by hardware, software, firmware, or any combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a general-purpose or special-purpose computer.

The objectives, technical solutions, and benefits of this application are further described in detail in the foregoing specific embodiments. It should be understood that the foregoing descriptions are merely specific embodiments of this application, but are not intended to limit the protection scope of this application. Any modification, equivalent replacement, or improvement made based on technical solutions of this application shall fall within the protection scope of this application.

1. A call setup method, implemented by a terminal, wherein the method comprises:
receiving a first notification message that comprises a first Internet Protocol (IP) multimedia subsystem (IMS) incoming call notification message;
establishing a first IMS call connection based on the first notification message;
allocating a resource for the first IMS call connection;
receiving a second notification message that comprises a circuit switched (CS) notification message, a first indication message from a network side device, or a second IMS incoming call notification message;
determining, based on the second notification message, whether the first IMS call connection is in an establishment process; and
releasing a resource occupied by the first IMS call connection when the first IMS call connection is in the establishment process.

2. (canceled)

3. The call setup method of claim 1, wherein the CS notification message comprises a CS incoming call notification message, a notification message indicating that a CS call connection is established, a message indicating that a CS call is to be set up, or a second indication message indicating that a CS call has ended.

4. The call setup method of claim 1, wherein the first indication message instructs the terminal to release the resource occupied by the first IMS call connection.

5. The call setup method of claim 1, wherein the second notification message is the second IMS incoming call notification message, wherein the first IMS incoming call notification message comprises a first calling number and a first call identifier, wherein the second IMS incoming call notification message comprises a second calling number and a second call identifier, and wherein releasing the resource occupied by the first IMS call connection comprises:
determining, via comparison, whether the first calling number is the same as the second calling number and whether the first call identifier is the same as the second call identifier; and
releasing the resource occupied by the first IMS call connection when the first calling number is the same as the second calling number and the first call identifier is different from the second call identifier.

6. The call setup method of claim 5, wherein after releasing, the resource occupied by the first IMS call connection, the method further comprises establishing a second IMS call connection based on the second IMS incoming call notification message.

7. A terminal, comprising:
a receiver configured to:
receive a first notification message that comprises a first Internet Protocol (IP) multimedia subsystem (IMS) incoming call notification message; and
receive a second notification message that comprises a circuit switched (CS) notification message, a first indication message from a network side device, or a second IMS incoming call notification message;
a connection establisher coupled to the receiver and configured to:
establish a first IMS call connection based on the first notification message; and
allocate a resource for the first IMS call connection; and
a connection releaser coupled to the receiver and configured to:
determine, based on the second notification message, whether the first IMS call connection is in an establishment process; and
release a resource occupied by the first IMS call connection when the first IMS call connection is in the establishment process.

8. (canceled)

9. The terminal of claim 7, wherein the CS notification message comprises a CS incoming call notification message, a notification message indicating that a CS call connection is established, a message indicating that a CS call is to be set up, or a second indication message indicating that a CS call ends.

10. The terminal of claim 7, wherein the first indication message instructs the terminal to release the resource occupied by the first IMS call connection.

11. The terminal of claim 7, wherein the second notification message is the second IMS incoming call notification message, wherein the first IMS incoming call notification message comprises a first calling number and a first call identifier, wherein the second IMS incoming call notification message comprises a second calling number and a second call identifier; and wherein the connection releasing device is further configured to:
determine, via comparison, whether the first calling number is the same as the second calling number, and whether the first call identifier is the same as the second call identifier; and
release the resource occupied by the first IMS call connection when the first calling number is the same as the second calling number and the first call identifier is different from the second call identifier.

12. The terminal of claim 11, wherein the connection establishment device is further configured to establish a second IMS call connection based on the second IMS incoming call notification message.

13. A terminal, comprising:
a processor coupled to the transceiver; and
a memory coupled to the processor and storing instructions that, when executed by the processor, cause the terminal to:
receive a first notification message that comprises a first Internet Protocol (IP) multimedia subsystem (IMS) incoming call notification message;
establish a first IMS call connection based on the first notification message;
allocate a resource for the first IMS call connection;
receive a second notification message that comprises a circuit switched (CS) notification message, a first indication message from a network side device, or a second IMS incoming call notification message;
determine, based on the second notification message, whether the first IMS call connection is in an establishment process; and
release a resource occupied by the first IMS call connection when the first IMS call connection is in the establishment process.

14.-15. (canceled)

16. The terminal of claim 13, wherein the second notification message comprises the circuit switched (CS) notification message.

17. The terminal of claim 13, wherein the second notification message comprises the first indication message.

18. The terminal of claim 13, wherein the CS notification message comprises a CS incoming call notification message, a notification message indicating that a CS call connection is established, a message indicating that a CS call is to be set up, or a second indication message indicating that a CS call has ended.

19. The terminal of claim 13, wherein the first indication message instructs the terminal to release the resource occupied by the first IMS call connection.

20. The terminal of claim 13, wherein the second notification message comprises the second IMS incoming call notification message.

21. The terminal of claim 20, wherein the second notification message is the second IMS incoming call notification message, wherein the first IMS incoming call notification message comprises a first calling number and a first call identifier, wherein the second IMS incoming call notification message comprises a second calling number and a second call identifier, and wherein the instructions cause the terminal to release the resource occupied by the first IMS call connection by causing the terminal to:
determine, via comparison, whether the first calling number is the same as the second calling number and whether the first call identifier is the same as the second call identifier; and
release the resource occupied by the first IMS call connection when the first calling number is the same as the second calling number and the first call identifier is different from the second call identifier.

22. The terminal of claim 20, wherein after releasing the resource occupied by the first IMS call connection, the instructions further cause the terminal to establish a second IMS call connection based on the second IMS incoming call notification message.

23. The terminal of claim 20, wherein the second notification message is the second IMS incoming call notification message, wherein the first IMS incoming call notification message comprises a first calling number and a first call identifier, wherein the second IMS incoming call notification message comprises a second calling number and a second call identifier, and wherein the instructions cause the terminal to release the resource occupied by the first IMS call connection by causing the terminal to:
determine, via comparison, whether the first calling number is the same as the second calling number and whether the first call identifier is the same as the second call identifier; and
reject a call request when the first calling number is different from the second calling number.

24. The terminal of claim 20, wherein the second notification message is the second IMS incoming call notification message, wherein the first IMS incoming call notification message comprises a first calling number and a first call identifier, wherein the second IMS incoming call notification message comprises a second calling number and a second call identifier, and wherein the instructions cause the terminal to release the resource occupied by the first IMS call connection by causing the terminal to:
determine, via comparison, whether the first calling number is the same as the second calling number and whether the first call identifier is the same as the second call identifier; and
send an acknowledgment message to indicate that the terminal received an IMS retransmission packet.
